(19) United States
(12) Patent Application Publication
(10) Pub. No.: US 2020/0337391 A1
(43) Pub. Date: Oct. 29, 2020

(54) Variable Transparent Clothes

(71) Applicant: WING TAK LEE SILICONE RUBBER TECHNOLOGY (SHENZHEN) CO., LTD, Shenzhen (CN)

(72) Inventor: Tak Nam Liu, Shenzhen (CN)

(21) Appl. No.: 16/544,934

(22) Filed: Aug. 20, 2019

(30) Foreign Application Priority Data
Apr. 26, 2019 (CN) 201910345445.6

(51) Int. Cl. A41D 1/00; G02F 1/133; G02F 1/137; G02F 1/1334

(52) U.S. Cl. CPC A41D 1/002; G02F 1/1334; G02F 1/137; G02F 1/13306

(57) ABSTRACT

The present application provides variable transparent clothes which comprise a protecting film, an intelligent film and a control circuit, the control circuit is used for controlling the intelligent film to be in a transparent state or in a non-transparent state, the intelligent film is used for converting the transparent state or the non-transparent state according to a signal of the control circuit. The technical solution provided by the present application has the advantage of improving the experience of a user.

### CROSS-REFERENCE TO RELATED APPLICATION

The present application is based upon and claims priority to Chinese patent application No. 201910345445.6, filed on Apr. 26, 2019, the entire content of which is incorporated herein by reference.

### TECHNICAL FIELD

The disclosure relates to the field of garments, and particularly to variable transparent clothes.

### BACKGROUND

Garment means a generic term of clothes, shoes, bags, toys, ornaments, etc., most referring to clothes. Garment has occurred at the early stage of human society development, and various materials found anywhere are made by ancient people into coarse and crude “clothing” to protect their bodies. Initially, human's clothes are made of hides, and the earliest “fabric” covering a body is made of bast fibers, grasses and the like.

For the present garment, such as clothes, its transparency is unchanged and cannot be switched depending on user's preference, and thus personalization cannot be achieved, thereby influencing the experience of a user.

### SUMMARY

An embodiment of the present application provides variable transparent clothes which can be switched between a transparent state and a non-transparent state, thereby improving the experience of a user.

The first embodiment of the present application provides variable transparent clothes, wherein the variable transparent clothes include a protecting film, an intelligent film and a control circuit,

the control circuit is used for controlling the intelligent film to be in a transparent state or in a non-transparent state,

the intelligent film is used for converting the transparent state or the non-transparent state according to a signal of the control circuit.

Preferably, the intelligent film includes a front conducting film, a rear conducting film and a middle component; the inner side surface of the front conducting film is adhered and fixed to the front surface of the middle component, the inner side surface of the rear conducting film is adhered and fixed to the rear surface of the middle component; the protecting film is adhered and fixed to the outer side surface of the front conducting film or the outer side surface of the rear conducting film; the middle component is a component having molecules ordering arrangement in an electric field and having molecules disordering arrangement without the electric field.

The implementation of the embodiment of the present application has the following beneficial effects:

it can be seen that the present application provides variable transparent clothes, the variable transparent clothes include an intelligent film which is a transparent film after being electrified, and a non-transparent film in a non-electrified state. In this way, whether the clothes are transparent or not can be determined depending on user's preference, and thus the present application has the advantage of improving the experience of a user.

### BRIEF DESCRIPTION OF THE DRAWINGS

For more clearly describing the technical solution in the embodiment of the present application, drawings used in the description of the embodiment will be simply described below, apparently, the drawings in the following description are some embodiments of the present application, and those of ordinary skill in the art can also obtain other drawings according to these drawings without creative efforts.

FIG. 1 is a schematic diagram of an appearance of variable transparent clothes according to an embodiment of the present application.

FIG. 1a is a schematic diagram of an internal structure of variable transparent clothes according to an embodiment of the present application.

FIG. 2 is a structural diagram of an intelligent film according to the embodiment of the present application.

FIG. 2a is an electrified light schematic diagram of an intelligent film according to the embodiment of the present application.

FIG. 2b is a non-electrified light schematic diagram of an intelligent film according to the embodiment of the present application.

FIG. 3 is a structural diagram of a control circuit according to the embodiment of the present application.

### DESCRIPTION OF THE EMBODIMENTS

The technical solution in embodiments of the present application will be clearly and completely described in combination with drawings in the embodiments of the present application below, apparently, the described embodiments are parts of embodiments of the present application, but not all the embodiments. Based on the embodiments of the present application, other embodiments obtained by those of ordinary skill in the art without creative efforts are all included within the protection scope of the present application.

Terms “first”, “second”, “third” and “fourth” or the like used in the specification and claims as well as the drawings of the present application are intended to distinguish different objects, but not describe a specific sequence. Furthermore, terms “including” and “having” as well as any transformations thereof are intended to cover non-exclusive comprising. For example, processes, methods, systems, products or devices comprising a series of steps or units are not limited to steps or units that have been listed, and optionally include steps or units that have not been listed, or optionally also include other steps or units that are inherent to these processes, methods, products or devices.

“Embodiment” mentioned herein means that specific features, structures or properties described in combination with the embodiments can be contained in at least one embodiment of the present application. Embodiments where this phrase occurs at various locations of the specification do not necessarily refer to the same embodiments, and are not independent or alternative embodiments mutually exclusive one another. It is explicitly and implicitly understood for those skilled in the art that embodiments described herein can be combined with other embodiments.

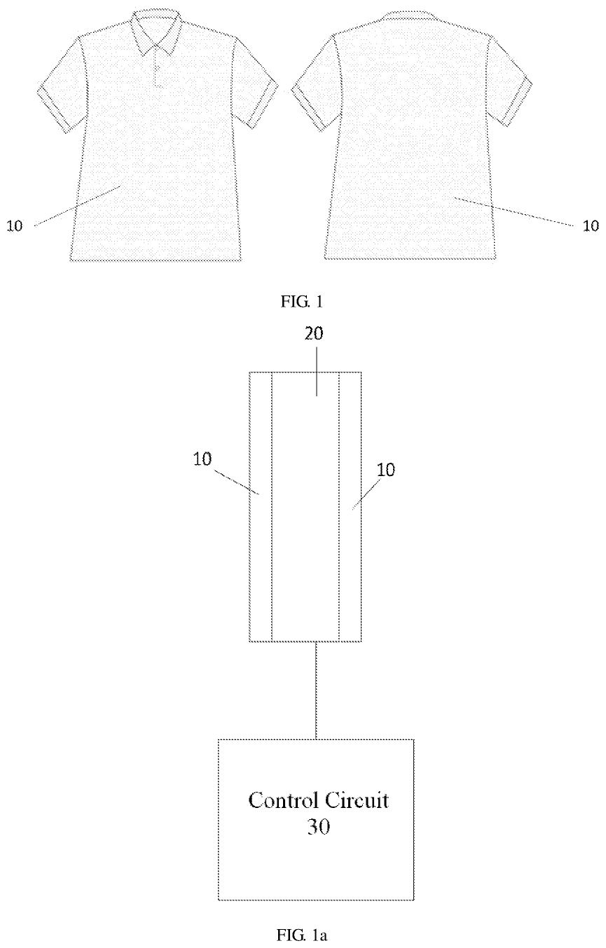

Referring to FIG. 1 and FIG. 1a, FIG. 1 is a schematic diagram of an appearance of variable transparent clothes. As shown in FIG. 1a, the variable transparent clothes include a protecting film 10, an intelligent film 20 and a control circuit 30, the control circuit 30 is used for controlling the intelligent film 20 to be in a transparent state or in a non-transparent state, the intelligent film 20 is used for converting the transparent state or the non-transparent state according to a signal of the control circuit.

The present application provides variable transparent clothes which include an intelligent film 20. The intelligent film 20 can be a transparent film after being electrified, and a non-transparent film in a non-electrified state. In this way, whether the clothes are transparent or not can be determined depending on user's preference. Thus, the present application has the advantage of improving the experience of a user.

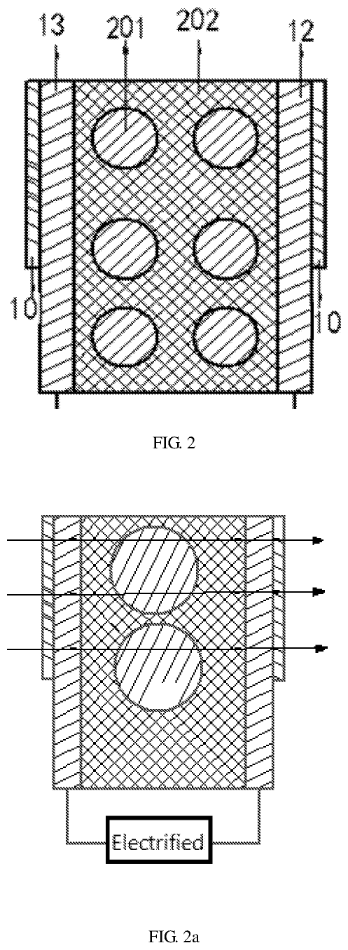

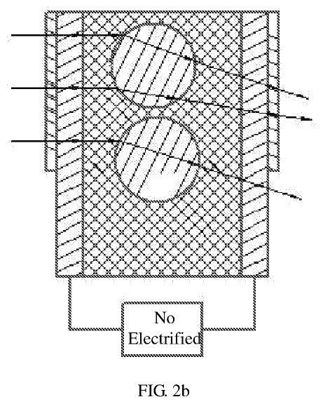

Preferably, the above intelligent film 20, as shown in FIG. 2, includes a front conducting film 12, a rear conducting film 13 and a middle component 20; the inner side surface of the front conducting film 12 is adhered and fixed to the front surface of the middle component, the inner side surface of the rear conducting film 13 is adhered and fixed to the back surface of the middle component 20; the protecting film 10 is adhered and fixed to the outer side surface of the front conducting film 12 or the outer side surface of the rear conducting film 13; the middle component is a component having molecules ordering arrangement in an electric field and having molecules disordering arrangement without the electric field, for example liquid crystal material.

The above middle component can be specifically composed of a mixture of a liquid crystal body 201 and a high polymer material filling material 202. The above liquid crystal body can be a liquid crystal display screen material, the above high polymer material filling material can be a light-transmitting high polymer material, the above liquid crystal body can specifically be a liquid crystal material having molecules ordering arrangement in an electric field and having molecules disordering arrangement without the electric field, for example, an orientation layer of a liquid crystal display screen.

Referring to FIG. 2a, FIG. 2a is a light-transmitting diagram of a structure as shown in FIG. 1 of the present application. As shown in FIG. 2b, FIG. 2b is a non-light-transmitting diagram of a structure as shown in FIG. 1 of the present application. As shown in FIG. 2a, if the control circuit 14 is electrified, the molecules of the liquid crystal body of the structure are arranged in an ordered form, at this moment, lights directly penetrate through the whole middle component, the structure has good light transmittance; if the control circuit is not electrified, molecules of the liquid crystal body of the structure are arranged in a disordered form, at this moment, lights can be reflected when penetrating through the liquid crystal body. As shown in FIG. 2b, the lights can be scattered, thereby achieving a light-proof purpose.

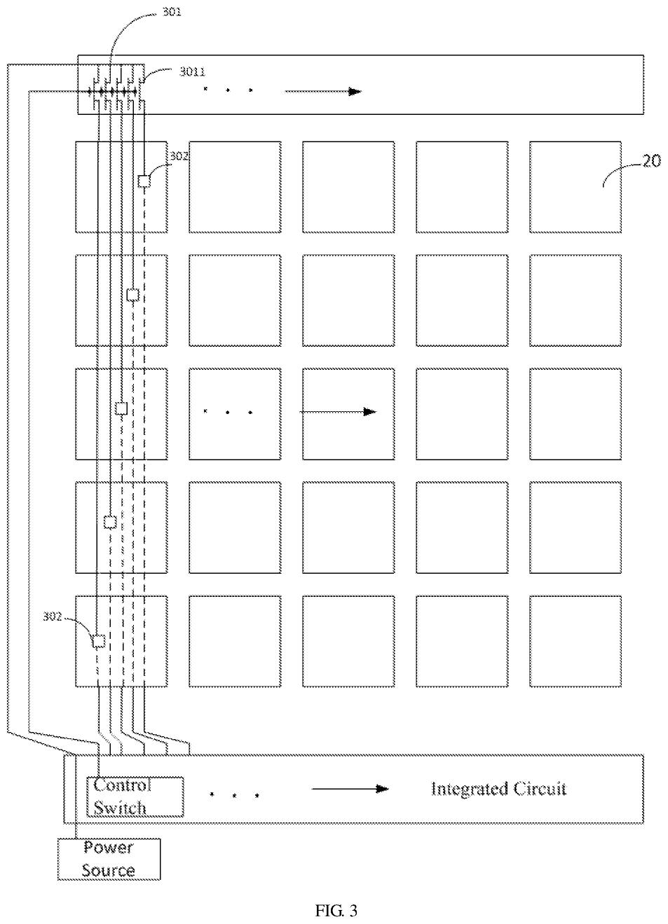

Referring to FIG. 3, FIG. 3 is an electric diagram of a control circuit 30 and an intelligent film 20. As shown in FIG. 3, this control circuit 30 can include an integrated circuit (specifically can be disposed at the bottom of the clothes), a power source (specifically can be disposed at the bottom of the clothes), a control switch, a switch tube stack 301 (specifically can be disposed at the shoulder or bottom of the clothes) and an electrode 302, wherein, the intelligent film 20 has plural numbers, a plurality of intelligent films 20 are arranged in an array, each column of intelligent films 20 has one switch tube stack 301, the switch tube stack 301 has m (m is a line number of arrays) switch tubes 3011, and each intelligent film 20 is correspondingly equipped with one switch tube 3011; the electrode 302 includes a front electrode and a back electrode, the front electrode is electrically connected with the front conducting film 12 of the intelligent film 20, the back electrode is electrically connected with the rear conducting film 13 of the intelligent film, a G pole of each switch tube is connected with the control switch, a collector of the switch tube is connected with the power source, an emitter is connected with the front electrode, and the back electrode is connected with the ground port of the integrated circuit through a wire.

The plurality of intelligent films can be attached and fixed to the protecting film.

The principle is as follows: based on selection of a user, a signal is emitted through the integrated circuit to control the switching-on or switching-off of the switch tube 3011, in such a way, whether the column of the intelligent film 20 is conducted can be controlled. If yes, the column has a transparent color, and if no, the column has a non-transparent color.

Preferably, the above control circuit can also include a communication unit, the communication unit is connected with the integrated circuit and also integrated in the integrated circuit, for example a Bluetooth module. The above integrated circuit can also be an integrated circuit with an antenna, for example MTK series chips (for example MT6737), Hisilicon chips or Qualcomm chips. The communication unit can be used for receiving a control command which is used for controlling the control switch to output a high level or a low level.

It is noted that for the sake of a brief description, the foregoing various method embodiments are described as a series of action combinations, but those skilled in the art should be aware that the present application is not limited by the described action sequence, as some steps can be performed in other sequences or simultaneously according to the present application. Secondly, those skilled in the art should also be aware that the embodiments described in the specification are all optional embodiments and the actions and modules involved are not necessarily required for the present application.

In the above embodiments, the description of each embodiment has its own emphasis, and parts that are not detailed in one embodiment can refer to the relevant descriptions of other embodiments.

In several embodiments provided by the present application, it is understood that the disclosed device can be achieved in other manners. For example, the above described device embodiments are only exemplary, for example, division of the units is only division of logical functions, other division manners can be present when in practical implementation, for example, multiple units or components can be combined or integrated to another system, or some features can be ignored, or not implemented. From another aspect, the displayed or discussed mutual coupling or direct coupling or communication connection can be indirect coupling or communication connection through some interfaces, devices or units, and can be in electrical or other forms.

The units described as separated components may be or may also not be physically separated. The components displayed as display units may be or may also be not physical units, namely, may be located at one place, or may also be distributed to multiple network units. Parts or all of the units here may be selected according to a practical need to achieve the purposes of the solutions of the embodiments of the present application.

In addition, various functional units in various embodiments of the present application can be integrated in one processing unit, or various units can be individually physically present, or two or more units can be integrated in one unit. The above integrated units can be achieved in a hardware form, or in a software program module.

When the integrated unit is achieved in a form of a software program module and sold or used as an independent product, it can be memorized in one computer readable memory. Based on this understanding, technical solutions of the present application substantively, or a part thereof making a contribution to the prior art, or all of or parts of this technical solution, may be reflected in the form of a software product stored in a memorizer, including several instructions to enable a computer equipment (e.g., personal computer, server, network facility, etc.) to execute all of or parts of the steps in the methods of respective embodiments of the present application. The memory mentioned above includes: a U disk, a read-only memory (ROM), a random access memory (RAM), a mobile hard disk, a disk or CD, and other media that can store program code.

It can be understood by those skilled in the art that all or parts of the steps in the various methods of the above embodiments can be accomplished by directing the relevant hardware through a program that can be stored in a computer readable memory, which may include: a flash disk, a read-only memory (ROM) and a random access memory (RAM), a disk or CD, etc.

The embodiments of the present application are described in detail above. The principle and implementation of the present application are described with specific examples herein. The description of the above embodiments is only used for helping to understand the method and core ideas of the present application. At the same time, for those of ordinary skill in the art, specific implementations and application scopes can all be varied according to the thought of the present application. In summary, the contents of this specification should not be construed as limiting the present application.

What is claimed is:

1. A variable transparent clothes comprising a protecting film, an intelligent film and a control circuit,
wherein the control circuit is configured for controlling the intelligent film to be in a transparent state or in a non-transparent state,
the intelligent film is configured for converting the transparent state or the non-transparent state according to a signal of the control circuit.

2. The variable transparent clothes of claim 1, wherein the intelligent film comprises a front conducting film, a rear conducting film and a middle component; the inner side surface of the front conducting film is adhered and fixed to the front surface of the middle component, the inner side surface of the rear conducting film is adhered and fixed to the rear surface of the middle component; the protecting film is adhered and fixed to the outer side surface of the front conducting film or the outer side surface of the rear conducting film; the middle component is a component having molecules ordering arrangement in an electric field and having molecules disordering arrangement without the electric field.

3. The variable transparent clothes of claim 2, wherein the middle component is composed of a mixture of a liquid crystal body and a high polymer material filling material.

4. The variable transparent clothes of claim 2, wherein the control circuit comprises an integrated circuit, a power source, a control switch, a switch tube stack and an electrode, the intelligent film has plural numbers, the plurality of intelligent films are arranged in an array, each column of intelligent films has one switch tube stack, the switch tube stack has m switch tubes, and each intelligent film is correspondingly equipped with one switch tube;
the electrode comprises a front electrode and a back electrode, the front electrode is electrically connected with the front conducting film of the intelligent film, the back electrode is electrically connected with the rear conducting film of the intelligent film, a G pole of each switch tube is connected with the control switch, a collector of the switch tube is connected with the power source, an emitter is connected with the front electrode, and the back electrode is connected with the ground port of the integrated circuit through a wire.

5. The variable transparent clothes of claim 4, wherein the control circuit further comprises a communication unit, the communication unit is used for receiving a control command of the peripheral device and the control command is used for controlling the control switch to output a high level or a low level.
